(19) United States
(12) Patent Application Publication
(10) Pub. No.: US 2004/0133659 A1
(43) Pub. Date: Jul. 8, 2004

(54) Remote object access

(76) Inventors: Martin M Lacey, Surrey (CA); David H J Glassco, Surrey (CA)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/474,932

(22) PCT Filed: Apr. 3, 2002
(86) PCT No.: PCT/IB02/01167

(51) Int. Cl. G06F 15/16; G06F 15/173

(52) U.S. Cl. 709/219; 709/223

(57) ABSTRACT

A remote object access facility is provided. The facility obtains description of objects hosted by a remote object server. The facility then facilitates creation of local instances of the remoted hosted objects for an application, and usage of the remotely hosted objects by the application through references to the “local” instances.

### RELATED APPLICATION

This application is a continuation-in-part application of U.S. patent application Ser. No. 09/771,515 entitled “Method and Apparatus For Managing Publication and Sharing of Data”, filed on Jan. 27, 2001. For the “new” matters, this application also claims priority to provisional applications Nos. 60/284,766 and 60/285,494, both entitled “Client Object Factory”, filed on Apr. 18, 2001 and Apr. 19, 2001 respectively. The specifications of the parent application as well as the two provisional applications are hereby fully incorporated by reference.

### BACKGROUND OF THE INVENTION

1. Field of the Invention

The present invention relates to the field of electronic data/information processing. More specifically, the present invention relates to methodologies, techniques and/or apparatuses associated with accessing and using objects hosted by a remote object server.

2. Background Information

With advances in microprocessor, telecommunication and networking technologies, and the availability of public data networks, such as the Internet, increasing number of computing devices are being interconnected together. As a result, increasing amount of application software are being offered as hosted application services remotely accessed using special or generic clients. Many of these application services, such as the financial applications or application services available from FinancialCAD of Surrey, Canada, assignee of the present application, are developed in an object oriented manner having data and function rich objects.

At the same time, the computing power of the client devices continue to increase. Thus, it is desirable that the data and function rich objects may be exploited in a distributed manner by other applications, beside those co-resident with the objects.

Current approaches to facilitate such distributed usage typically involve the employment of a new paradigm, as exemplified by the “.NET” technology offered by Microsoft Corporation of Redmond, Wash., where a new set of Web Services are employed to access the objects as raw XML contents. Such technologies suffer from the obvious disadvantage of requiring application developers to acquire a new set of skills and use a new set of tools.

Accordingly, an approach that facilitates the desired distributed usage of these data and function rich objects, and yet maintains more continuity with the traditional object oriented programming technology is desired.

### SUMMARY OF THE INVENTION

A remote object access facility is provided. The facility obtains description of objects hosted by a remote object server. The facility then facilitates creation of “local” instances of the remoted hosted objects for an application, and usage of the remotely hosted objects by the application through references to the “local” instances.

In one embodiment, the description of the objects is obtained at the time when a user session is initialized on the remote object server for a remote user.

In one embodiment, the facility also includes functions for creating an hierarchical model of the objects hosted, and functions for traversing the model.

In one embodiment, the “local” instances creatable include object collection instances and singleton object item instances. The “usage” facilitated includes obtaining current states of the hosted objects, permanently storing current states of the “local” instances into corresponding objects on the remote object server, having calculations performed by the remote object server on behalf of “local” applications and the results of the calculations made available to the “local” applications.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates a component view of the remote object server of FIG. 1, in accordance with one embodiment;

FIG. 3 illustrates the relationship between the various entities of the remote object server of FIG. 1, in accordance with one embodiment;

FIG. 4 illustrates a data organization of the administrator/user information, in accordance with one embodiment;

FIGS. 5a-5b illustrate properties and methods of a component object of FIG. 1, in particular, the security attributes, in accordance with one embodiment;

FIG. 6 illustrates a function offering/service creation and authorizing method of the parent invention, in accordance with one embodiment;

FIGS. 7a-7b illustrate a data organization of the function offering/service creation and management tool, in accordance with one embodiment;

FIG. 8 illustrates the “local” object structure, in accordance with one embodiment;

FIG. 9 illustrates a segment of an exemplary description of the hosted objects, in accordance with one embodiment;

FIG. 10 illustrates an overview of the function offering/service execution method of the present invention, in accordance with one embodiment;

FIG. 11 illustrates the relevant operational flow of the runtime controller of FIG. 7, in accordance with one embodiment;

FIG. 12 illustrates a network environment suitable for practicing the present invention, in accordance with one embodiment; and

FIG. 13 illustrates an example computer system suitable for use as one of the administrator/user computer of FIG. 12 to practice the present invention, in accordance with one embodiment.

### Glossary

| | |
|---|---|
| HTTP | Hypertext Transmission Protocol |
| XML | Extended Markup Language |

### DETAILED DESCRIPTION OF THE INVENTION

As summarized earlier, the present invention includes a remote object facility that facilitates distributed applications to access and use the data and function rich objects hosted by a remote object server. In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as objects, methods, and so forth, commonly employed by those skilled in the art to convey the substance of their work to others skilled in the art. Parts of the description will be presented in terms of operations performed by a computer system, using terms such as obtaining, creating, using, and so forth. As is well understood by those skilled in the art, these quantities and operations take the form of electrical, magnetic, or optical signals capable of being stored, transferred, combined, and otherwise manipulated through mechanical and electrical components of a digital system.

Various operations will be described as multiple discrete steps performed in turn in a manner that is most helpful in understanding the present invention, however, the order of description should not be construed as to imply that these operations are necessarily order dependent. In particular, the method needs not necessarily performed in the order presented, although it may. Similarly, the phrase “in one embodiment” will be used repeatedly. The phrase, in general, does not refer to the same embodiment, although it may.

### Overview

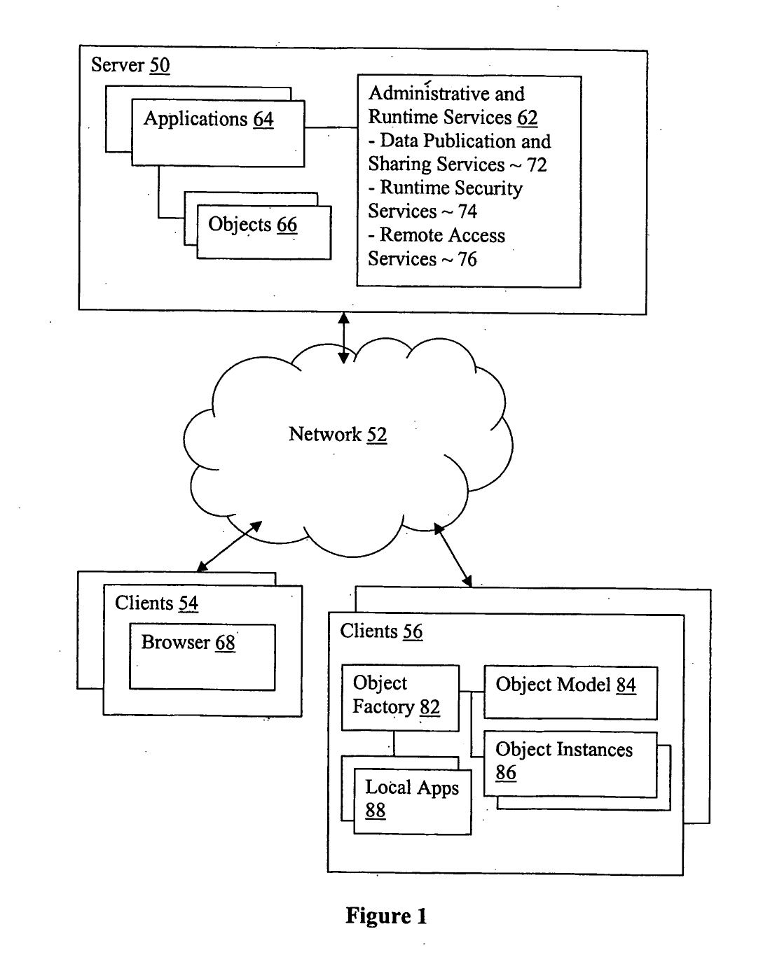

Referring now to FIG. 1, wherein an overview of the present invention in accordance with one embodiment is shown. As illustrated, in accordance with the present invention, client computing devices 56 (hereinafter, simply clients) are advantageously provided with remote object access facility 82 of the present invention (hereinafter, also referred to as “object factory”) to facilitate access and usage of objects 66 (hosted by remote object server 50) by “local” applications 88. The term “object” as used in the present application refers to programmatic software entities having data and methods, as the term is commonly understood in the context of object oriented programming.

In addition to objects 66, server 50 also includes administrative/runtime services 62 and applications 64 (formed using objects 66). Among the services offered by administrative/runtime services 62 are data publication and sharing services 72, runtime security services 74, and remote access services 76. Among the services offered by data publication and sharing services 72 and runtime security services 74 are security services to enable data to be published and subscribed to, i.e. shared, among users of applications 64. Accordingly, users of distributed client computing devices 54 (hereinafter, also simply clients) may access and use applications 64 (including objects 66), using generic user agents, such as browsers 68.

However, with remote access service 76 and object factory 82, users of clients 56 may access and use objects 66 in conjunction with “local” applications 88 instead, i.e. as if “local” applications 88 are formed with remote objects 66. Object factory 82 advantageously obtains the descriptions of objects 66 for “local” applications 88. Using these descriptions, object factory 82 models objects 66 (illustrated as object model 84), and facilitates “local” applications 88 in creating “local” instances of objects 66 (illustrated as object instances 86), and using objects 66 through references to these “local” instances.

In one embodiment, “local” applications 88, are co-resident with object factory 82. In alternate embodiments, “local” applications 88 need not be co-resident with object factory 82. They are merely both distributedly disposed away from object server 50 of objects 66. Object factory 82 and “local” applications 88 may communicate with each other using any one of a number of “remote” communication techniques, such as remote procedure calls, known in the art. Accordingly, the term “local” as used in this application is to be so broadly construed.

Server 50, notwithstanding its singular form, as used in the present application, may include one or more digital data processing machines known in the art. It is referred to “singulady” as its functions are so seen from the perspective of clients 54 and 56. Clients 54 and 56 may be any numbers of digital “computing” devices known in the art, including but are not limited to wireless mobile phones, palm sized personal digital assistants, notebook computers, desktop computers, set top boxes, and the like. Clients 54-56 are coupled to server 50 via network 52, which represents one or more private and/or public networks interconnected together. In one embodiment, network 52 represents the Internet.

Object factory 82, in particular, the manner it facilitates “local” applications 88 in accessing and using remotely hosted objects 66 will be described in turn in more details below. However, before doing so, application services 62, including in general, how objects 66 (including their data and functions) are packaged together and offered as application services, in accordance with one embodiment, will first be described. Further, it should be noted that applications 88 are intended to represent a broad range of applications known in the art, including in particular financial applications such as those offered by the assignee of the present invention. Moreover, while for ease of understanding, the present invention is presented in the context of applications 88, from the description to follow, those skilled in the art would appreciate that the present invention may be practiced for other system/subsystem software products or services, as well as other multi-media contents, including but not limited to video, audio and graphics. Accordingly, unless specifically limited, the term “application” as used herein in this patent application, including the specification and the claims, is intended to include system and subsystem software products and services, as well as multi-media contents.

### Remote Object Server

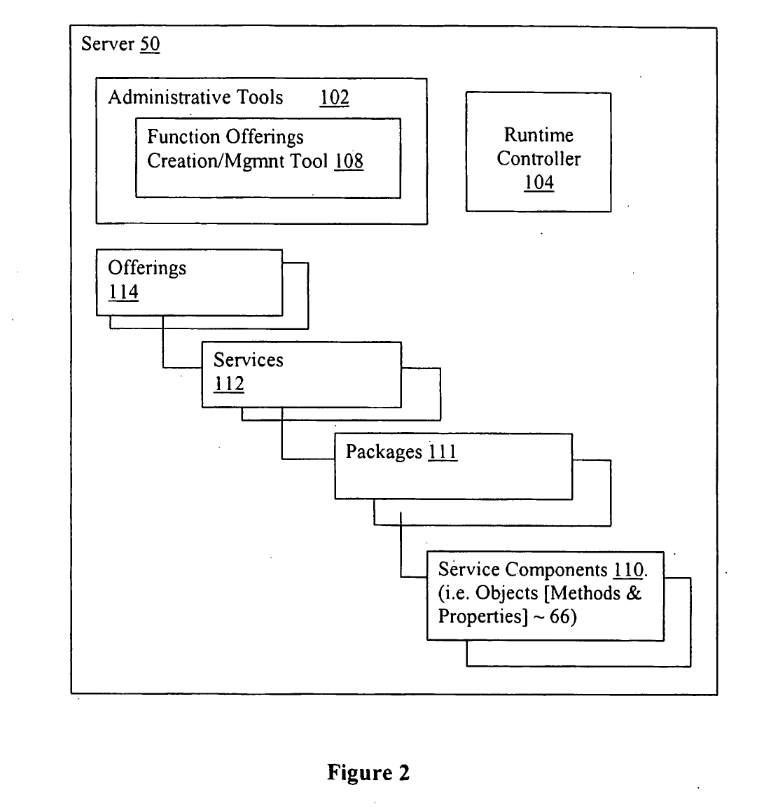

Referring now to FIG. 2, wherein a block diagram illustrating remote object server 50 of FIG. 1 in further details, in accordance with one embodiment, is shown. As illustrated, remote object server 50 having a number of service components 110 (formed with objects 66) is also provided with a number of administration tools 102 and runtime controller 104 to facilitate administration and management of user access and usage of components 110.

For the illustrated embodiment, service components 110 (hereinafter, simply components) are selectively packaged into packages 111, which in turn are packaged into services 112, and then function offerings 114 for administration and management, i.e. licensing and access/usage control. As alluded to earlier, components 110 are constituted with objects 66. Packages 111 are groupings of interdependent components 110 similar in functional scope. Services 112 are logical groupings of service functionality that when combined with other services provide broader information processing support. Functional offerings 114 are sets of services offered and licensed to licensees.

Administration tools 104 include in particular administrator/user account creation/management (ACM) tool (not shown) and function offering/service creation/management (FCM) tool 108. Briefly, ACM tool is equipped to facilitate creation of various administrator and end user accounts for various administrators and end users, including facilitation of empowerment of various administrators to administer control on user access to functional offerings 114. For a more detailed description of the ACM tool and the process of creating and administering user accounts, see the incorporated by reference descriptions of the parent application.

FCM tool 106 is equipped to facilitate creation of the various function offerings 114 and services 112, including empowering of the various administrators in administering control on user access to components 110, through invocation of function offerings 114 and/or services 112.

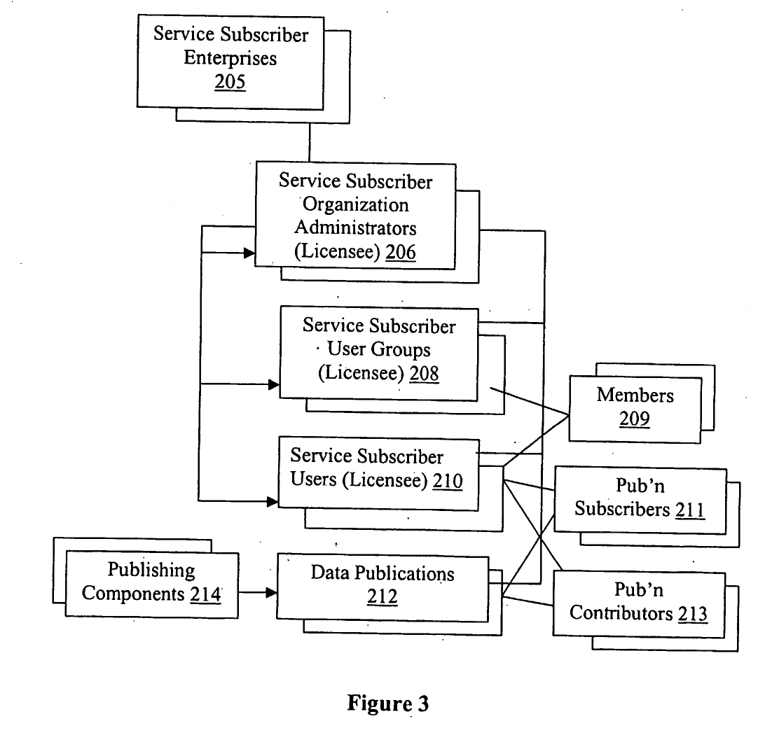

FIG. 3 illustrates an overview of the relationship between selected entities of server 50 in accordance with one embodiment. As illustrated, an empowered administrator of server 50 (not shown) creates administrator accounts for administrators 206 of service subscription licensee organizations/enterprises 205. For the embodiment, the empowered administrator also empowers administrators 206 of the licensee organization to create user groups 208 and user accounts for users 210 of the respective licensee organizations, and to administer control on user access to components 110 (through access to functional offerings 114 or services 112) within the respective licensee organizations.

For the purpose of this application, licensee organizations are constituting organization units of service subscription licensee enterprises. Each licensee enterprise 205 may have one or more licensee organizations. The organization unit may be a wholly owned subsidiary, a division, a group, or a department. In other words, it may be any one of a number of internal business entities. Moreover, an empowered administrator 206 of a licensee organization may also create one or more user groups 208, and associates users 210 as members 209 of user groups 208. Similarly, in alternate embodiments, the present invention may also be practiced without the employment of user groups or with more levels of user organizations.

As illustrated, administrators 206 of each licensee organization may create data publications 212 to facilitate data sharing. Administrators 206 first minimally define a number of data publications, e.g. their topics. Administrators 206 designate selected ones of its users 210 as eligible shared data contributors 213, and selected ones of the authorized service components of data contributors 213 as publishing components 214. Thereafter, contributors 213 selectively tags data managed by their authorized ones of publishing components 204 for inclusion with data publications 212 as desired. For the illustrated embodiment, data publications 212 are available for subscription across licensee organization boundaries. Administrators 206 further define which if any of extra-organizational data publications 212 are available for subscriptions by “eligible” users 210 of the licensee organization. Administrators 206 designate these “eligible” users 210 as publication subscribers 211. Subscribers 211 can then on their own subscribe to available data publications 212. Of course, a user may be designated as a contributor 213 as well as a subscriber 211 for the same or different data publications 212.

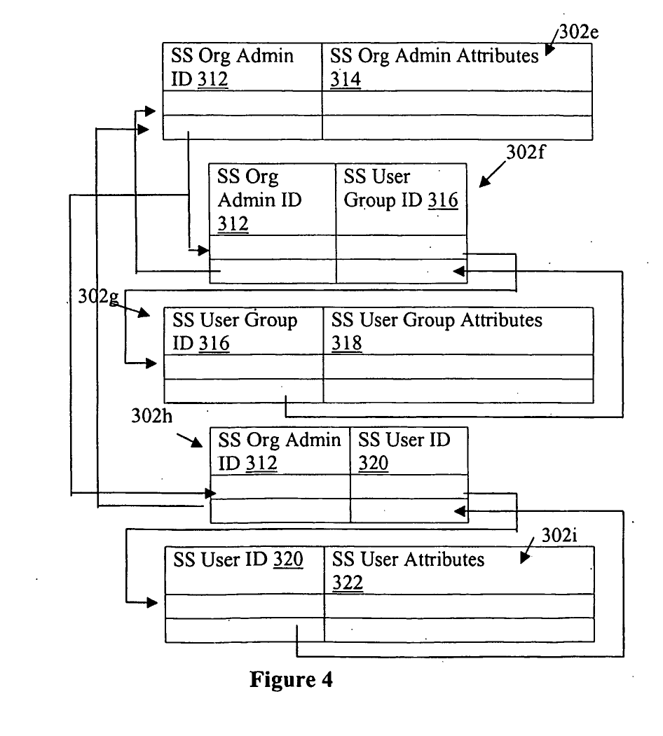

FIG. 4 illustrates a data organization associated with the ACM, in accordance with one embodiment. As illustrated, data organization 300 includes tables or views 302e-302i (hereinafter, simple table or tables). Table 302e is used to store an identifier 312 and basic attribute information 314 for each administrator account of a licensee organization created. Likewise identifier 312 may be formed in any manner employing any convention, and attribute information 314 may also include any typical account associated information, such as the organization administrator's name, customer number, department number, phone number and so forth. The exact composition of these attributes is also not essential to the present invention, accordingly will not be further described either.

Tables 302f and 302h are used to store user group identifiers 316 and end user identifiers 320 created by the various administrators of the licensee organization denoted by organization administrator identifiers 312. Tables 302g and 302i are used to store an identifier 316 and basic attribute information 318 for each user group created, and an identifier 320 and basic attribute information 322 for each end user account created respectively. Likewise identifiers 316 and 320 may be formed in any manner employing any convention, and attribute information 318 and 322 may also include any typical account associated information, such as the user group/end user's name, customer number, department number, phone number and so forth. The exact composition of these attributes is also not essential to the present invention, accordingly will not be further described either.

In alternate embodiments, other equivalent data organizations include but not limited to flat files, hierarchical databases, linked lists, and so forth, may also be employed instead to practice the present invention.

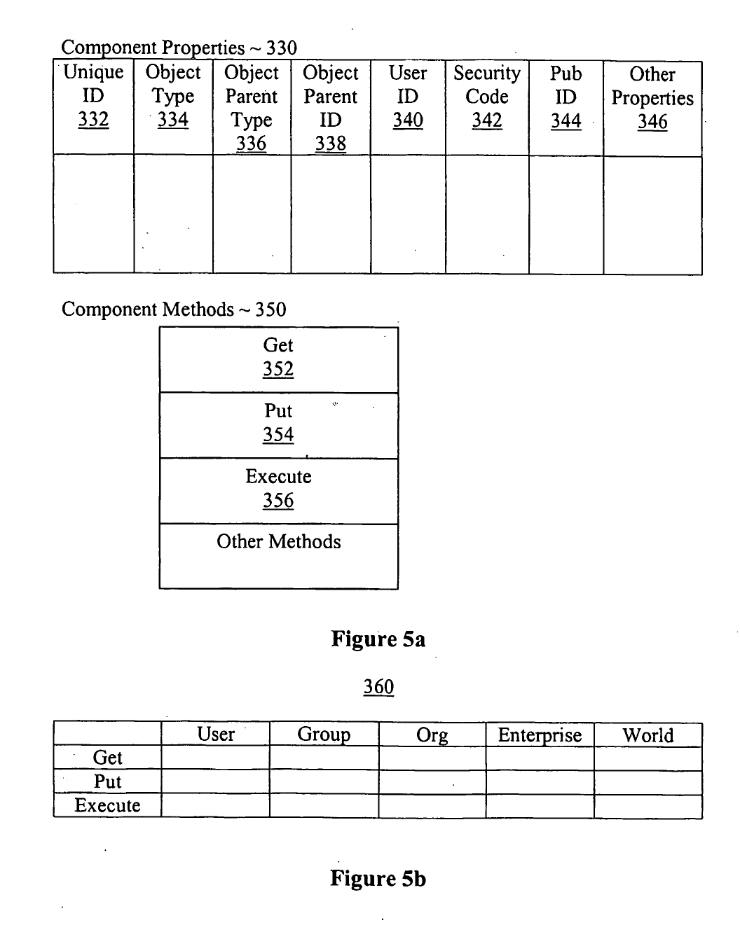

FIGS. 5a-5b illustrate in further detail the properties of a component 110, its methods, including in particular, the security property associated with each component 110. As illustrated in FIG. 5a, for the embodiment, each component 110 includes a unique identifier 332 identifying the component, and a type property 334 to identify the object type of the component. Further, each component 110 includes properties 338 and 336 describing the parent object's identifier and the object type of the parent object respectively. Additionally, each component 110 includes property 340 identifying the user owner, property 342 identifying the access rights the user owner has granted to others, and if applicable, property 344 identifying the data publication with which the component is associated with. As illustrated, component 110 may also include other properties 346.

As alluded to earlier, each component 110 has a number of methods. For the illustrated embodiment, the methods 350 include at least a Get method 352 for retrieving data associated with the component and other applicable subscribed publishing components, a Put method 354 to store a copy of data present in the component into memory or mass storage, and an Execute method 356 to perform a pre-determined computation using the data of the component and other applicable subscribed publishing components. Of course, each component 110 may also include other methods.

As illustrated in FIG. 5b, each user owner specifies for himself/herself and other data sharing entities the rights to use these methods, i.e. the Get Method, the Put Method, and the Execute Method. If a data sharing entity is authorized to use the method, all members of the data sharing entity are authorized. In other words, authorization of the members are implicitly given. If authorized, the corresponding “cell” of “table” 360 is set to “true”, otherwise it is set to “false”, denoting the members of the data sharing entity are not authorized to use the method. For example, if a user authorizes himself/herself to use all three methods, then all three “cells” in “column” 1 of “table” 360 are set to “true” or “1”. As a further example, if other members of a group to which the user belongs to is authorized to use the Get method, then the “cell” in “column” 2, “row” 1 of “table”360 is set to “true” or “1”, and the remaining “cells” in “column” 2, i.e. “rows” 2-3 of “table”360 are set to “false”. The “cells” of the remaining Org, Enterprise and World columns are set accordingly. [Note that “table” 360 is employed for illustrative purpose only. The authorization data may be stored in any one of a number of known data structures.]

For the illustrated embodiment, for efficiency of storage and efficiency of processing, each digital representation of “1”s and “0”s of a combination of authorized usage of these methods for the various entities is “reduced” to a numeric value and stored in security field 342 for use during operation to control access to the data managed by the components.

In one embodiment, the reduction is performed by a secure runtime service that supports the user owner in making the authorization. For a more detailed description of security administration, see the incorporated by reference description of the parent application.

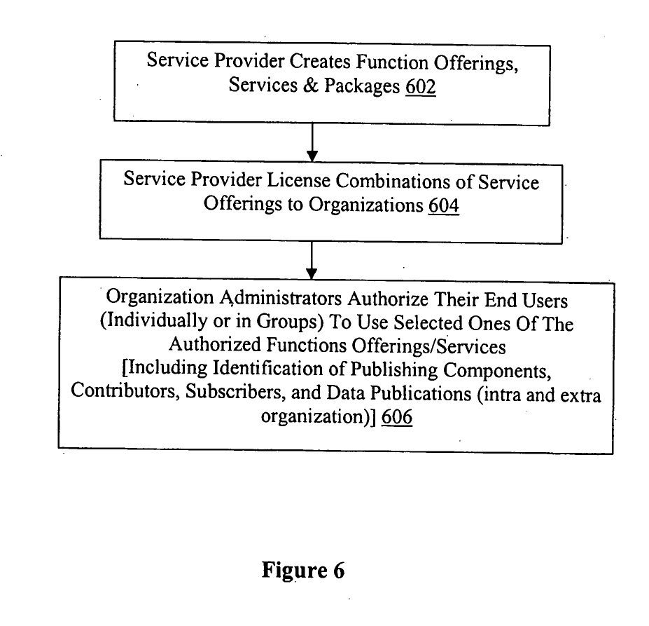

FIG. 6 illustrates the function offering/service creation and access control method practiced on server 50, in accordance with one embodiment. As illustrated, for the embodiment, a service operator administrator defines and creates various function offerings and services, enumerating their constituting services and service components respectively, and selectively empowers the various service provider administrators to administer control on user access to various ones of the function offerings and/or services, block 602. In turn, for the illustrated embodiment, an empowered service provider administrator selectively empowers the various organization administrators to administer control on user access to various ones of the function offerings and/or services, block 604. Then, an empowered organization administrator selectively enables members of the user groups and various end users to access various ones of the function offerings and/or services, block 606. For the illustrated embodiment, the selective enablement includes selective designation of users as contributors, authorized service components as publishing components, and definition of data publications, as well as designation of available data publications, and users as subscribers, eligible to subscribe to available data publications on their own.

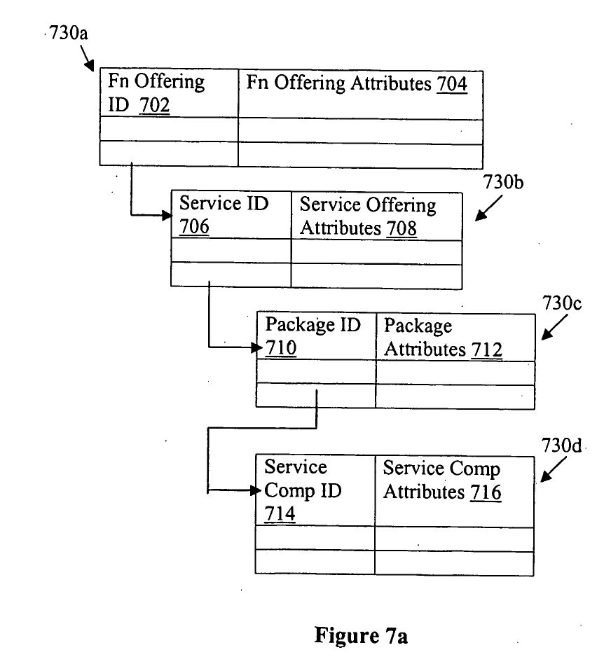

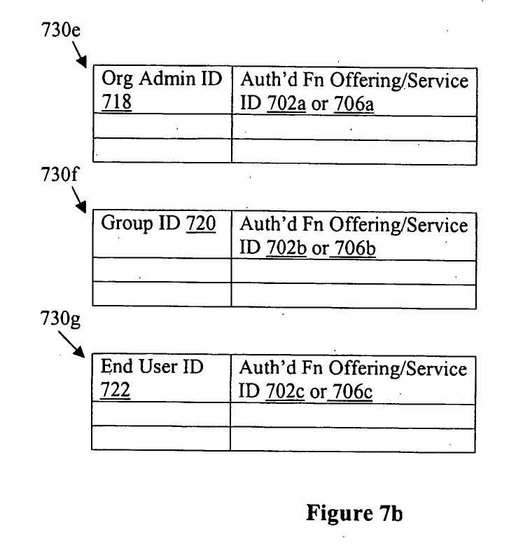

FIGS. 7a-7b illustrate a data organization associated with FCM 108, in accordance with one embodiment. As illustrated, for the embodiment, data organization 700 includes tables/views (hereinafter simply tables) 730a-730g. Table 730a is used to store an identifier 702 and basic attribute information 704 for each function offering created. Identifier 702 may be formed in any manner, employing any convention. Attribute information 704 includes in particular pointers to the constituting services. Beyond that, attribute information 704 may include any typical offering description associated information, such as the offering's name, date of creation, date of last modification, and so forth. The exact composition of these other attributes is not essential to the present invention, accordingly will not be further described. Table 730b is used to store an identifier 706 and basic attribute information 708 for each constituting service created. Similarly, identifier 706 may be formed in any manner, employing any convention. Likewise, attribute information 708 includes in particular pointers to the constituting packages. Beyond that, attribute information 708 may include any typical service description associated information, such as the service's name, date of creation, date of last modification, and so forth. The exact composition of these other attributes is also not essential to the present invention, accordingly will not be further described either.

In like manner, table 730c is used to store an identifier 710 and basic attribute information 712 for each constituting package. Similarly, identifier 710 may be formed in any manner, employing any convention. Attribute information 712 may include any typical package description associated information, such as the package's name, date of creation, date of last modification, and so forth. The exact composition of these other attributes is also not essential to the present invention, accordingly will not be further described either. Table 720d is used to store an identifier 714 and basic attribute information 716 for each constituting service component. Similarly, identifier 714 may be formed in any manner, employing any convention. Attribute information 716 may include any typical service component description associated information, such as the service component' name, date of creation, date of last modification, and so forth, as well as those properties enumerated earlier referencing FIG. 3d. In the present context, the term “attributes” and “properties” may be considered as synonymous. The exact composition of these other attributes/properties, except for the enumerated ones, is also not essential to the present invention, accordingly will not be further described either.

Table 730e is used to store the identifiers 702a and 706a of the various function offerings and services, the various organization administrators (denoted by identifiers 718) are empowered (i.e. authorized) to administer control on their accesses. Tables 730f-730g are used to store the identifiers 702b-702c and 706b-706c of the various function offerings and services, the various end users (denoted by identifiers 720-722) are enabled to access.

In alternate embodiments, these data may be organized differently. Further, different data structures may be employed to store the data. For a more detailed description of the FCM 108, its associated data structures and methods of operation, see the incorporated by reference description of the parent application.

### Object Factory

Having now described remote object server 50, in particular, the manner in which data may be published and subscribed to, i.e. shared, among users, we turn now to describe the remote object access facility, i.e. object factory 82, and its associated elements, of the present invention.

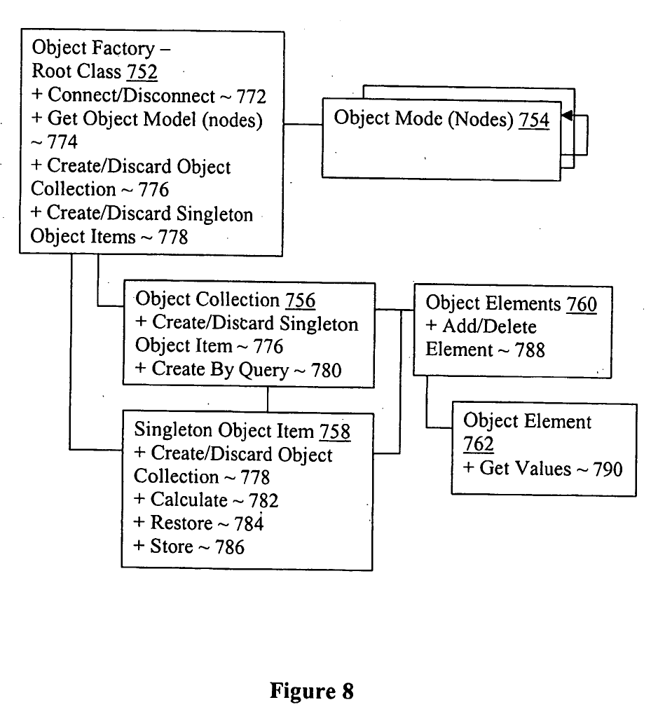

FIG. 8 illustrates object factory 82 and its associated elements, in accordance with one embodiment. As shown, for the embodiment, object factory 82 includes a root class 752. Associate with root class 752 includes in particular, connect/disconnect method 772, get object method (nodes) 774, create/discard a object collection instance 776 and create/discard a singleton object item instance 778.

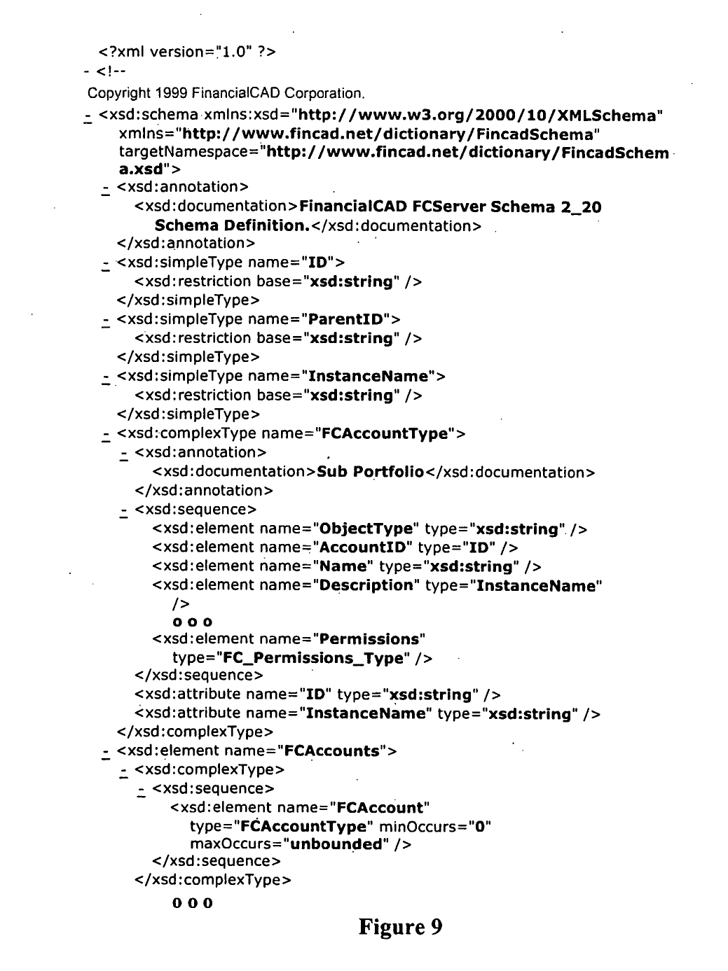

Connect/disconnect method 772 is invoked to connect and disconnect a client from remote object server 50. In one embodiment, client is connected to remote object server 50 via a HTTP connection. Further, as part of the connect process, connect/disconnect method 772 requests to have a user session established on remote object server 50 for a use of the client. Also as part the process of establishing the user session, connect/disconnect method 772 obtains and is provided by remote object server 50 a description of the objects hosted. In one embodiment, for efficiency of operation, the description describes all objects hosted, without regard to whether the user is authorized to access the particular objects. Security is enforced at a subsequent point in time when access is requested. Further, the description is dynamically constructed reflecting all objects potentially available at the time the user session is established. In one embodiment, the description is expressed in XML. A segment of one such example XML description is shown in FIG. 9.

In alternate embodiments, the description may be pre-generated. The description may also be described using other machine interpretable languages beside XML. Further, the description may include only the objects the user is authorized to use.

Continuing to refer to FIG. 8, for the illustrated embodiment, also as part of the connect process, a “local” hierarchical model of the objects hosted 754 is constructed, with each node representing one of the objects hosted. Get object method (nodes) 774 is provided to enable a “local” application 88 to recursively traverse the hierarchical model, and learn of the available objects. In alternate embodiments, additional “list” functions may also be supported to allow “local” applications 88 to efficiently learn and/or present the hosted objects to a user.

Create/discard object collection method 776 is provided to allow “local” applications 88 to create and discard “local” object collection instances 756; and create/discard singleton object item method 778 is provided to allow “local” applications 88 to create and discard “local” singleton object item instances 758. Each “local” singleton object item instance 758 corresponds to an object hosted by remote object server 50. Each “local” singleton object item instance 758 may be created as child objects of root class 752 or as child objects of a “local” object collection instance 756. Each “local” singleton object item instance 758 in turn may have one or more “local” object collection instances 756 created as child objects of the “local” singleton object item instances 758. Accordingly, for the embodiment, both create/discard object collection method 776 and create/discard singleton object item method 778 are associated with root class 752, as well as with singleton object item class 758 and object collection class 756 respectively. As those skilled in the art would appreciate, the recursive architecture flexibly enables object hierarchies of any depth to be modeled.

Additionally, associated with the object collection class 756 is a create by query method 782, which is provided to allow a singleton object instance 758 to be created as a child object of an object collection instance 756, based on the result of a query against the remote objects hosted. Further, associated with singleton object item class 758 are calculate method 782, restore method 784 and store method 786. Calculate method 782 is provided to allow a “local” application 88 to request a calculation to be performed on remote object server 50 using the corresponding hosted object, and having the results be made available to the “local” application 88. Restore method 784 is provided to allow a “local” application 88 to refresh a “local” singleton object item instance 758 to the current state of the corresponding object hosted by remote object server 50. Store method 786 is provided to allow a “local” application 88 to persistent store the current state of a “local” singleton object item instance 758 into the corresponding object hosted by remote object server 50. As alluded to earlier, all calculations, refreshing “local” instances to current states of hosted objects, and storing current states of “local” instances into persistent storage of corresponding hosted objects, are all effectuated, with “local” applications 88 transparently referencing the “local” instances.

For the illustrated embodiment, associated with each object collection class 756 and each singleton object item class 758 is an object elements class 760 comprising the properties of the object collection class 756 and the singleton object item class 758. Each object elements class 760 may have one or more object element instances 762 comprising the property values. Associated with the object elements class 760 is add/delete element method 788 to facilitate a “local” application 88 in creating and deleting the properties associated with an object collection class 756 or a singleton object item class 758. Associated with the object element class 762 is get values method 790 to facilitate a “local” application 88 in retrieving the current value of a property. In one embodiment, multiple versions of get values method 790 are provided to provide different methods for obtaining the property values of different value types, strings, ordinals, and the like.

Implementation of each of these methods, given the above descriptions and the descriptions to follow, is within the ability of those skilled in the art. Accordingly, the individual methods will not be further described. Further, while for ease of understanding, some of the methods are described as having dual functions and purposes, e.g. the “create/delete” methods, which are provided for creating the object instances and discarding the created instances, and other methods are described as having singular functions, e.g. the “refresh” and “store” methods, the present invention may be practiced with some or all of these functions being reorganized into different method implementations. For example, the “create and discard” functions may be separately implemented with separate methods, and the “refresh” and “store” methods may be jointly implemented via a single method.

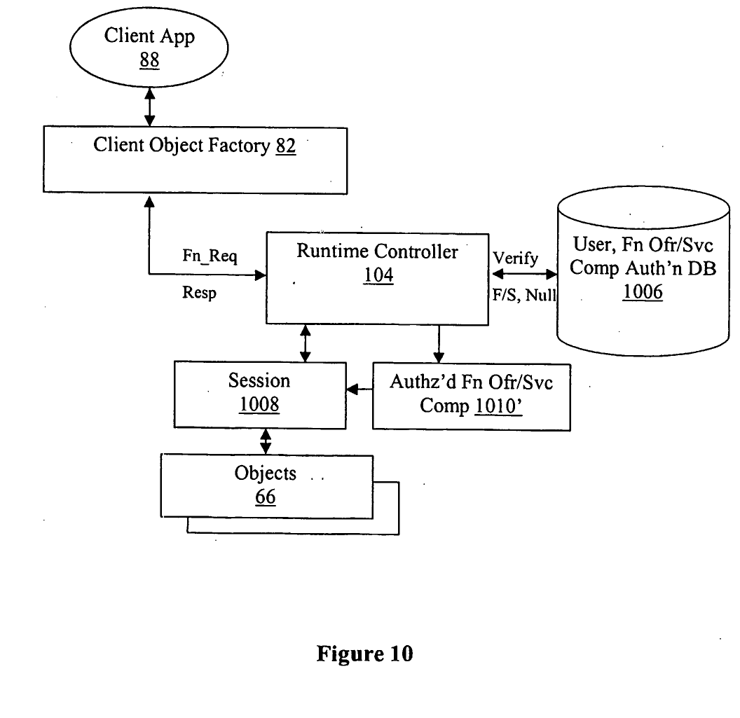

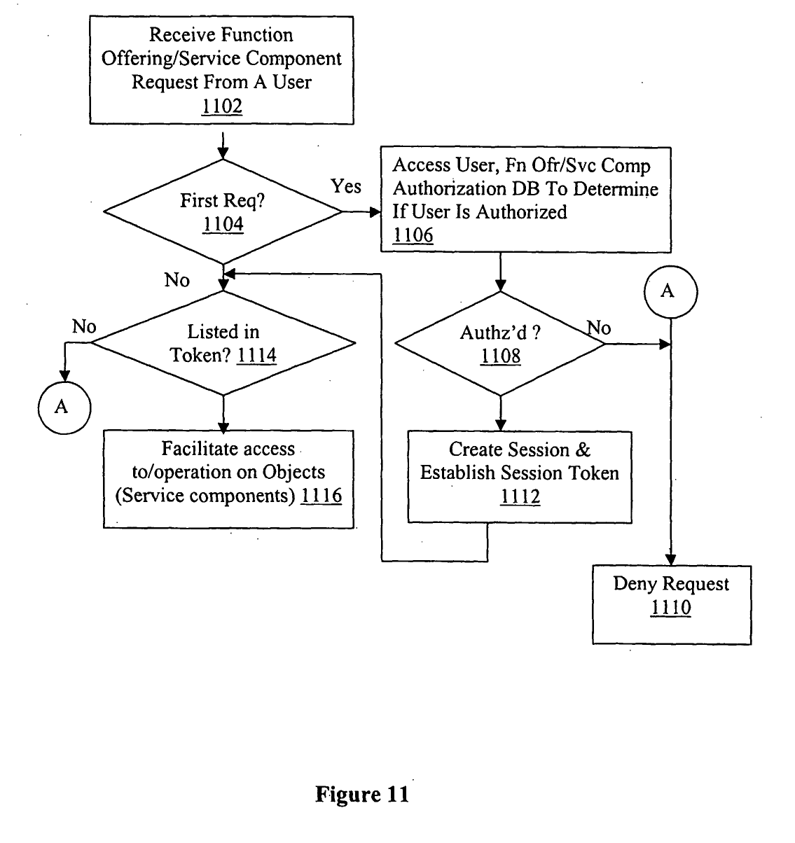

Referring now to FIGS. 10 and 11, wherein two block diagrams illustrating the manner in which the runtime control of server 50 and a client object factory 82 interact, in accordance with one embodiment, are shown. As illustrated in FIG. 10, a “local” application 88, on behalf of a user, and via the “local” object factory 82 submits a function request (Fn_Req) to runtime controller 104 (block 1102). The function request may e.g. be a request to establish a user session (as part of the connect process), to access and obtain the value of a hosted object, to request a calculation be performed using one or more hosted objects, to store values into the hosted objects, and so forth.

In response, runtime controller 104 determines if this is the first request from the user, i.e. whether a session environment has previously been created for the requesting user (block 1104). If the request is the first request and the session environment is yet to be created, runtime controller 104 accesses users and function offerings/services authorization database 1008 to verify that the user is “enabled”, i.e. authorized to access at least one service or function offering (blocks 1106 and 1108). In one embodiment, if user is “enabled”, runtime controller 104 also accesses users and function offerings/services authorization database 1008 to determine if the user is an eligible shared data subscriber, and if so, his/her subscriptions, if any. Users and function offerings/services authorization database 1008 includes a data organization having user, function offering/service authorization and enabling information similar to the data organization earlier described referencing FIGS. 7a-7b, and components 110 having security properties 342 as earlier described referencing FIG. 5b. Further, in an embodiment where data sharing through publication and subscription as earlier described is supported, database 1008 further includes data publications and data subscriptions of the subscriber users.

If the user is not “enabled” (authorized) to access at least one service or function offering, the request is rejected or denied (block 1110). If the user is “enabled” (authorized) to access at least one service or function offering, runtime controller 104 establishes a session environment 1008 for the user, instantiates various runtime services for the session 1008, retrieves a token 1010 listing all the authorized function offerings and services of the user, and associates token 1010 with session 1008 (block 1112). In an embodiment where data sharing through publication and subscription as earlier described is supported, token 1010 further includes identification of data managed by publishing components of the user's subscribed data publications, if any. For the earlier described publication and subscription approach, applicable ones of the data managed by publishing components are resolved through the publication identifier properties of the publishing components and the subscribed data publications.

Upon doing so, or earlier determining that the request is not a first request, and such a session environment had been previously established for the user, runtime controller 1004 transfers the request to an appropriate runtime service to handle. Thereafter, the runtime services retrieve and instantiate the appropriate service components or objects associated with the requested service or applicable services associated with the requested function offering 1014 in accordance with whether the requested services/function offerings are among the authorized ones listed in token 1010 created for the session 1008. Further, during execution, the user is conditionally given access to use the earlier described Get, Put, and Execute method associated with the “authorized” service components, depending on whether the user has been given the right to access these methods (blocks 1114-1116). Recall a non-user owner is implicitly given the right to use these methods, for being a member of an authorized user group of the user owner, or a fellow user of the authorized organization/enterprise of the user owner. Alternatively, the non-user owner may have been implicitly given the right to use these methods because the user owner has granted access right to an universal data sharing entity (such as “world”).

Moreover, in an embodiment where data sharing through publication and subscription as earlier described is supported, the user is conditionally given access to data managed by the authorized service components as well as data managed by the publishing components of the subscribed data publications.

Contributor users contribute to data managed by the publishing components of the data publications the users are so designated, by accessing and modifying these data. Contributor users are conditionally given access to these components and data in like manner as subscriber users are conditionally given access, as earlier described.

The earlier referenced runtime services are intended to represent a broad range of such services, including but are not limited to memory allocation services, program loading and initialization services, certain database or data structure interfacing functions, and so forth. In alternate embodiments, security token 1010 may be statically pre-generated and/or dynamically updated to reflect dynamic changes in publications and subscriptions.

### Example Network Environment

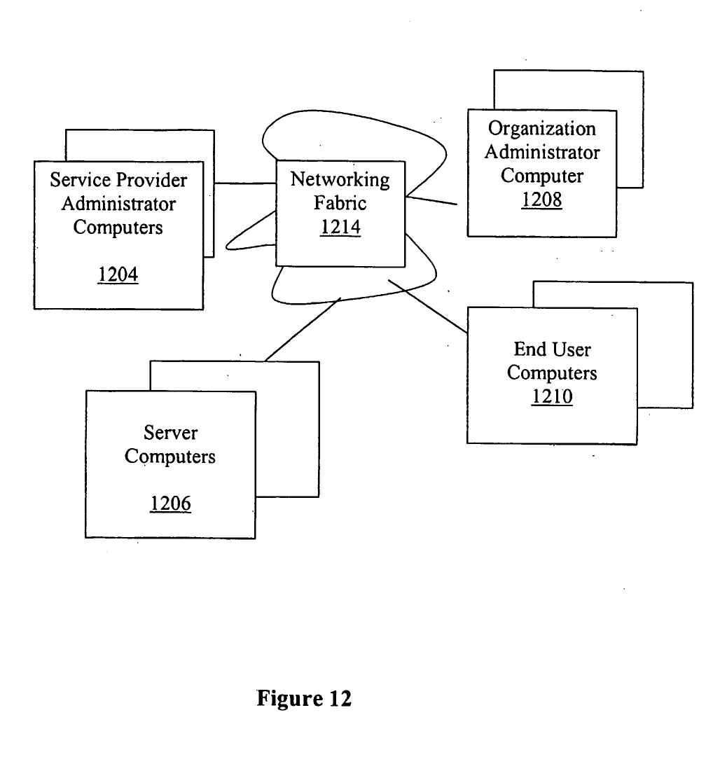

FIG. 12 illustrates a network environment suitable for practicing the present invention. As illustrated, network environment 1200 includes service provider administrator computers 1204, server computers 1206, organization administrator computers 1208, and end user computers 1210. The computers are coupled to each other through networking fabric 1214.

Server computers 1206 are equipped with the earlier described objects based applications 64 including administration tool 102 and runtime controller 104. In selected implementations, all or part of FOM 108 are instantiated onto the respective computers 1204 and 1208-1210 for execution. Similarly, for selected ones of function offerings 114, services 112, packages 111 or service components 110, all or part of these offerings, services, packages or service components are invoked by end user computers 1210 for execution.

In one embodiment, service provider administrator computers 1204 and server computer 1206 are affiliated with the vendor of applications 64, while organization administrator computers 1208, and end user computers 1210 are affiliated with customers or service subscribers of applications 64.

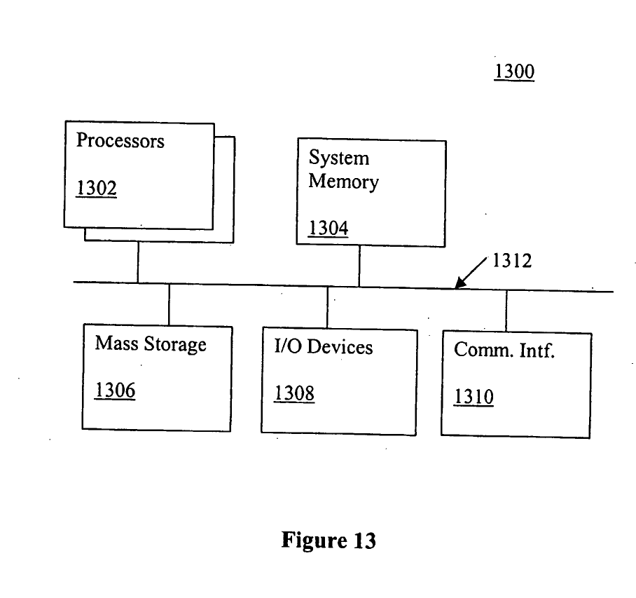

Computers 1204-1210 are intended to represent a broad range of computers known in the art, including general purpose as well as special purpose computers of all form factors. An example computer suitable for use is illustrated in FIG. 13. Networking fabric 1214 is intended to represent any combination of local and/or wide area networks, including the Internet, constituted with networking equipment, such as hubs, routers, switches as the like.

### Example Computer

As alluded to earlier, FIG. 13 illustrates an example computer system suitable for use to practice the present invention. As illustrated, example computer system 1300 includes one or more processors 1302 (depending on whether computer system 1300 is used as server computer 1206 or other administrator/end user computers 1204 and 1208-1210), and system memory 1304 coupled to each other via “bus” 1312. Coupled also to “bus” 1312 are non-volatile mass storage 1306, input/output (I/O) devices 1308 and communication interface 1314. During operation, memory 1304 includes working copies of programming instructions implementing teachings of the present invention.

Except for the teachings of the present invention incorporated, each of these elements is intended to represent a wide range of these devices known in the art, and perform its conventional functions. For example, processor 1302 may be a processor of the Pentium® family available from Intel Corporation of Santa Clara, Calif., or a processor of the PowerPC® family available from IBM of Armonk, N.Y. Processor 1302 performs its conventional function of executing programming instructions, including those implementing the teachings of the present invention. System memory 1304 may be SDRAM, DRAM and the like, from semiconductor manufacturers such as Micron Technology of Boise, Id. Bus 1312 may be a single bus or a multiple bus implementation. In other words, bus 1312 may include multiple buses of identical or different kinds properly bridged, such as Local Bus, VESA, ISA, EISA, PCI and the like.

Mass storage 1306 may be disk drives or CDROMs from manufacturers such as Seagate Technology of Santa Cruz of Calif., and the like. Typically, mass storage 1306 includes the permanent copy of the applicable portions of the programming instructions implementing the various teachings of the present invention. The permanent copy may be installed in the factory, or in the field, through download or distribution medium. I/O devices 1308 may include monitors of any types from manufacturers such as Viewsonic of City, State, and cursor control devices, such as a mouse, a track ball and the like, from manufacturers such as Logictech of Milpitas, Calif. Communication interface 1310 may be a modem interface, an ISDN adapter, a DSL interface, an Ethernet or Token ring network interface and the like, from manufacturers such as 3COM of San Jose, Calif.

### Conclusion and Epilog

Thus, a method and an apparatus for facilitating access to remotely hosted objects have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. A computing method comprising:
obtaining from a remote object server a schema describing a plurality of objects hosted by the remote object server;
facilitating creation by an application, instances of selected ones of the remotely hosted objects, using the obtained description of the selected objects; and
facilitating usage of the selected ones of the remotely hosted objects by the application through references to the created instances of the selected ones of the remotely hosted objects.

2. The method of claim 1, wherein the method further comprises establishing a connection to said remote object server, and establishing a user session on said object server for a user; and said obtaining is performed as an integral part of said establishing of the user session.

3. The method of claim 2, wherein said establishing of a connection comprises establishing a HTTP connection to said remote object server.

4. The method of claim 1, wherein said schema describes said objects using the extended Markup Language.

5. The method of claim 1, wherein said facilitating of creation of instances of said remotely hosted objects comprises creating an hierarchical model of the remotely host objects.

6. The method of claim 1, wherein said facilitating of creation of instances of said remotely hosted objects comprises creating for said application one or more object collection instances corresponding to one or more of said selected ones of said remotely hosted objects, responsive to one or more object collection instance creation requests of said application.

7. The method of claim 6, wherein said facilitating of creation of instances of said remotely hosted objects further comprises creating for said application one or more singleton object item instances corresponding to one or more of said selected ones of said remotely hosted objects as child objects of one or more of said created object collection instances, responsive to one or more singleton object item creation requests of said application.

8. The method of claim 7, wherein said one or more singleton object item creation requests comprise queries against one or more of said selected ones of said remotely hosted objects, and said singleton object item instances are created using the results of said queries.

9. The method of claim 1, wherein said facilitating of creation of instances of said remotely hosted objects comprises creating for said application one or more singleton object item instances corresponding to one or more of said selected ones of said remotely hosted objects, responsive to one or more singleton object item creation requests of said application.

10. The method of claim 9, wherein said facilitating of creation of instances of said remotely hosted objects further comprises creating for said application one or more object collection instances corresponding to one or more of said selected ones of said remotely hosted objects as child objects of one or more of said created singleton object item instances, responsive to one or more object collection creation requests of said application.

11. The method of claim 9, wherein said facilitating of usage of the selected ones of the remotely hosted objects by the application through references to the created instances of the selected ones of the remotely hosted objects comprises submitting calculation requests to the remote object server to perform calculations involving one or more of the selected ones of the remote hosted objects, responsive to calculation requests of said application referencing corresponding ones of the singleton object item instances.

12. The method of claim 11, wherein said facilitating of usage of the selected ones of the remotely hosted objects by the application through references to the created instances of the selected ones of the remotely hosted objects further comprises updating said corresponding ones of the singleton object item instances upon completion of requested calculation by said remote object server.

13. The method of claim 9, wherein said facilitating of usage of the selected ones of the remotely hosted objects by the application through references to the created instances of the selected ones of the remotely hosted objects comprises updating one or more of the selected ones of the remotely hosted objects with current states of corresponding ones of the singleton object item instances, responsive to storing requests of said application referencing said corresponding ones of the singleton object item instances.

14. The method of claim 9, wherein said facilitating of usage of the selected ones of the remotely hosted objects by the application through references to the created instances of the selected ones of the remotely hosted objects comprises restoring one or more of the singleton object item instances to current states of corresponding ones of the selected ones of the remotely hosted objects, responsive to restoring requests of said application referencing said one or more singleton object item instances.

15. The method of claim 1, wherein said facilitating of creation of instances of said remotely hosted objects comprises creating for said application one or more property elements for one or more of the created instances of said selected ones of said remotely hosted objects, responsive to one or more property element creation requests of said application.

16. The method of claim 15, wherein said facilitating of usage of the selected ones of the remotely hosted objects by the application through references to the created instances of the selected ones of the remotely hosted objects comprises returning to said application one or more values of one or more of the created property elements of one or more of the created instances of said selected ones of said remotely hosted objects, responsive to one or more property element value requests of said application.

17. The method of claim 1, wherein the method further comprises facilitating discarding for said application said created instances of said selected ones of the remotely hosted objects.

18. A computing method comprising:
creating for an application one or more object collection instances corresponding to first one or more of selected ones of objects hosted by a remote object server, responsive to one or more object collection instance creation requests of said application;
creating for said application one or more singleton object item instances corresponding to second one or more of the selected ones of said remotely hosted objects as child objects of one or more of said created object collection instances, responsive to one or more singleton object item creation requests of said application; and
facilitating usage of the selected ones of the remotely hosted objects by the application through references to the created object collection instances and the created singleton object item instances of the selected ones of the remotely hosted objects.

19. The method of claim 18, wherein said one or more singleton object item creation requests comprise queries against said second one or more of said selected ones of said remotely hosted objects, and said singleton object item instances are created using the results of said queries.

20. A computing method comprising:
creating for an application one or more singleton object item instances corresponding to first one or more of selected ones of objects hosted by a remote object server, responsive to one or more singleton object item creation requests of said application;
creating for said application one or more object collection instances corresponding to second one or more of the selected ones of said remotely hosted objects as child objects of one or more of said created singleton object item instances, responsive to one or more object collection creation requests of said application; and
facilitating usage of the selected ones of the remotely hosted objects by the application through references to the created object collection instances and the created singleton object item instances of the selected ones of the remotely hosted objects.

21. The method of claim 20, wherein said facilitating of usage of the selected ones of the remotely hosted objects by the application through references to the created object collection instances and the created singleton object item instances of the selected ones of the remotely hosted objects comprises submitting calculation requests to the remote object server to perform calculations involving third one or more of the selected ones of the remote hosted objects, responsive to calculation requests of said application referencing corresponding ones of the singleton object item instances.

22. The method of claim 21, wherein said facilitating of usage of the selected ones of the remotely hosted objects by the application through references to the created object collection instances and the created singleton object item instances of the selected ones of the remotely hosted objects further comprises updating said corresponding ones of the singleton object item instances upon completion of requested calculation by said remote object server.

23. The method of claim 20, wherein said facilitating of usage of the selected ones of the remotely hosted objects by the application through references to the created object collection instances and the created singleton object item instances of the selected ones of the remotely hosted objects comprises updating third one or more of the selected ones of the remotely hosted objects with current states of corresponding ones of the singleton object item instances, responsive to storing requests of said application referencing said corresponding ones of the singleton object item instances.

24. The method of claim 20, wherein said facilitating of usage of the selected ones of the remotely hosted objects by the application through references to the created object collection instances and the created singleton object item instances of the selected ones of the remotely hosted objects comprises restoring one or more of the singleton object item instances to current states of corresponding ones of the selected ones of the remotely hosted objects, responsive to restoring requests of said application referencing said one or more singleton object item instances.

25. A computing method comprising:
creating for an application one or more singleton object item instances corresponding to first one or more of selected ones of objects hosted by a remote object server, responsive to one or more singleton object item creation requests of said application;
creating for said application one or more object collection instances corresponding to second one or more of the selected ones of said remotely hosted objects, responsive to one or more object collection creation requests of said application;
creating for said application one or more property elements for selected ones of said created object collection instances and said singleton object item instances, responsive to one or more property element creation requests of said application; and
facilitating usage of the selected ones of the remotely hosted objects by the application through references to the created object collection instances and the created singleton object item instances of the selected ones of the remotely hosted objects.

26. The method of claim 25, wherein said facilitating of usage of the selected ones of the remotely hosted objects by the application through references to the created object collection instances and the created singleton object item instances of the selected ones of the remotely hosted objects comprises returning to said application one or more values of one or more of the created property elements of one or more of the created object collection instances and the created singleton object item instances of said selected ones of said remotely hosted objects, responsive to one or more property element value requests of said application.

27. An apparatus comprising:
a storage medium having stored therein a plurality of programming instructions implementing a remote object access facility that, when executed, enable the apparatus to
obtain from a remote object server a schema describing a plurality of objects hosted by the remote object server,
facilitate creation by an application, instances of selected ones of the remotely hosted objects, using the obtained description of the selected objects, and
facilitate usage of the selected ones of the remotely hosted objects by the application through references to the created instances of the selected ones of the remotely hosted objects; and
at least one processor coupled to the storage medium to execute said programming instructions.

28. The apparatus of claim 27, wherein said remote object access facility, when executed, includes with said enabling of the apparatus to facilitate creation of instances of said remotely hosted objects, enabling of the apparatus to create for said application one or more object collection instances corresponding to one or more of said selected ones of said remotely hosted objects, responsive to one or more object collection instance creation requests of said application.

29. The apparatus of claim 27, wherein said remote object access facility, when executed, includes with said enabling of the apparatus to facilitate creation of instances of said remotely hosted objects, enabling of the apparatus to create for said application one or more singleton object item instances corresponding to one or more of said selected ones of said remotely hosted objects, responsive to one or more singleton object item instance creation requests of said application.

30. The apparatus of claim 27, wherein said remote object access facility, when executed, includes with said enabling of the apparatus to facilitate creation of instances of said remotely hosted objects, enabling of the apparatus to create for said application one or more object property elements for one or more of said created objection collection instances and said created singleton object item instances, responsive to one or more object property element creation requests of said application.

31. An apparatus comprising:
a storage medium having stored therein a plurality of programming instructions implementing a remote object access facility that, when executed, enable the apparatus to
create for an application one or more object collection instances corresponding to first one or more of selected ones of objects hosted by a remote object server, responsive to one or more object collection instance creation requests of said application,
create for said application one or more singleton object item instances corresponding to second one or more of the selected ones of said remotely hosted objects as child objects of one or more of said created object collection instances, responsive to one or more singleton object item creation requests of said application, and
facilitate usage of the selected ones of the remotely hosted objects by the application through references to the created object collection instances and the created singleton object item instances of the selected ones of the remotely hosted objects; and
at least one processor coupled to the storage medium to execute said programming instructions.

32. The apparatus of claim 31, wherein said remote object access facility, when executed, includes with said enabling of the apparatus to facilitate creation of instances of said remotely hosted objects, enabling of the apparatus to service singleton object item creation requests that are queries against said second one or more of said selected ones of said remotely hosted objects, and to create said singleton object item instances using the results of said queries.

33. An apparatus comprising:
a storage medium having stored therein a plurality of programming instructions implementing a remote object access facility that, when executed, enable the apparatus to
create for an application one or more singleton object item instances corresponding to first one or more of selected ones of objects hosted by a remote object server, responsive to one or more singleton object item creation requests of said application,
create for said application one or more object collection instances corresponding to second one or more of the selected ones of said remotely hosted objects as child objects of one or more of said created singleton object item instances, responsive to one or more object collection instance requests of said application, and
facilitate usage of the selected ones of the remotely hosted objects by the application through references to the created object collection instances and the created singleton object item instances of the selected ones of the remotely hosted objects; and
at least one processor coupled to the storage medium to execute said programming instructions.

34. The apparatus of claim 33, wherein said remote object access facility, when executed, includes with said enabling of the apparatus to facilitate usage of the selected ones of said remotely hosted objects, enabling of the apparatus to submit calculation requests to the remote object server to perform calculations involving third one or more of the selected ones of the remote hosted objects, responsive to calculation requests of said application referencing corresponding ones of the singleton object item instances.

35. The apparatus of claim 33, wherein said remote object access facility, when executed, includes with said enabling of the apparatus to facilitate usage of the selected ones of said remotely hosted objects, enabling of the apparatus to update third one or more of the selected ones of the remotely hosted objects with current states of corresponding ones of the singleton object item instances, responsive to storing requests of said application referencing said corresponding ones of the singleton object item instances.

36. The apparatus of claim 33, wherein said remote object access facility, when executed, includes with said enabling of the apparatus to facilitate usage of the selected ones of said remotely hosted objects, enabling of the apparatus to restore one or more of the singleton object item instances to current states of corresponding ones of the selected ones of the remotely hosted objects, responsive to restoring requests of said application referencing said one or more singleton object item instances.

37. An apparatus comprising:
a storage medium having stored therein a plurality of programming instructions implementing a remote object access facility that, when executed, enable the apparatus to
create for an application one or more singleton object item instances corresponding to first one or more of selected ones of objects hosted by a remote object server, responsive to one or more singleton object item creation requests of said application;
create for said application one or more object collection instances corresponding to second one or more of the selected ones of said remotely hosted objects, responsive to one or more object collection creation requests of said application;
create for said application one or more property elements for selected ones of said created object collection instances and said singleton object item instances, responsive to one or more property element creation requests of said application; and
facilitate usage of the selected ones of the remotely hosted objects by the application through references to the created object collection instances and the created singleton object item instances of the selected ones of the remotely hosted objects; and
at least one processor coupled to the storage medium to execute said programming instructions.

38. The apparatus of claim 37, wherein said remote object access facility, when executed, includes with said enabling of the apparatus to facilitate usage of the selected ones of said remotely hosted objects, enabling of the apparatus to return to said application one or more values of one or more of the created property elements of one or more of the created object collection instances and the created singleton object item instances of said selected ones of said remotely hosted objects, responsive to one or more property element value requests of said application

39. A computing method comprising:
receiving a request from a remote object access facility to establish a user session for a remote user;
in response, establishing said user session for said remote user; and
providing said remote object access facility with a schema describing objects hosted to enable said remote object access facility to facilitate usage of said hosted objects by a remote application of the remote user.

40. The method of claim 39, wherein said schema describes said objects using the extended Markup Language.

41. The method of claim 39, wherein the method further comprises
receiving an access request from said remote object access facility to access a selected one of said hosted objects on behalf of said user;
conditionally servicing said access request based on whether said user is authorized to access the requested object.

42. The method of claim 39, wherein the method further comprises
receiving an operation request from said remote object access facility to perform an operation associated a selected one of said hosted objects on behalf of said user;
conditionally servicing said operation request based on whether said user is authorized to perform said requested operation in association with the selected one of the host objects.

43. An apparatus comprising:
a storage medium having stored therein a plurality of programming instructions implementing an object hosting service that, when executed; enable the apparatus to
receive a request from a remote object access facility to establish a user session for a remote user,
establish, in response, said user session for said remote user, and
provide said remote object access facility with a schema describing objects hosted to enable said remote object access facility to facilitate usage of said hosted objects by a remote application of the remote user; and
at least one processor coupled to the storage medium to execute said programming instructions.

44. The apparatus of claim 43, wherein the object hosting service, when executed, also enables the apparatus to receive an access request from said remote object access facility to access a selected one of said hosted objects on behalf of said user, and conditionally service said access request based on whether said user is authorized to access the requested object.

45. The apparatus of claim 43, wherein the object hosting service, when executed, also enables the apparatus to receive an operation request from said remote object access facility to perform an operation associated a selected one of said hosted objects on behalf of said user, and conditionally service said operation request based on whether said user is authorized to perform said requested operation in association with the selected one of the host objects.
